(19) United States
(12) Patent Application Publication
(10) Pub. No.: US 2026/0070421 A1
(43) Pub. Date: Mar. 12, 2026

(54) CALIBRATING VEHICLE SURROUNDINGS SENSORS OF A VEHICLE IN A PRODUCTION LINE

(71) Applicant: Ford Global Technologies, LLC, Dearborn, MI (US)

(72) Inventors: Mohsen Lakehal-ayat, Aachen/NRW (DE); Mohamed Benmimoun, Köln/NRW (DE); Muhammad Adeel Awan, Aachen/NRW (DE); Ahmed Benmimoun, Aachen/NRW (DE)

(73) Assignee: Ford Global Technologies, LLC, Dearborn, MI (US)

(21) Appl. No.: 19/263,591

(22) Filed: Jul. 9, 2025

(30) Foreign Application Priority Data
Jul. 11, 2024 (DE) 102024119740.4

(51) Int. Cl. B60K 35/90; B60K 35/81

(52) U.S. Cl. CPC B60K 35/90; B60K 35/81

(57) ABSTRACT

A vehicle surroundings sensor module on board a vehicle is connected to a one vehicle surroundings sensor and is configured, in a calibration mode, to progressively transmit vehicle surroundings sensor data captured by the vehicle surroundings sensor via a wireless communication interface to a calibration server when the vehicle is moved through a calibration area, which comprises at least one section of a production line, at least one stationary surroundings sensor, which is configured to capture surroundings sensor data of a set of reference objects in the calibration area and to transmit these data to the calibration server, and at least one stationary position sensor, which is configured, during the movement of the vehicle through the calibration area, to progressively capture a position of the vehicle and transmit vehicle position data to the calibration server. The calibration server is configured to associate captured vehicle position data with the received vehicle surroundings sensor data, which capture the set of reference objects, and, using associated surroundings sensor data of the set of reference objects, to ascertain calibration parameters for the vehicle surroundings sensor and transmit these parameters to the vehicle surroundings sensor module.

### CROSS-REFERENCE TO RELATED APPLICATION

This patent application claims priority to German Application No. DE 102024119740.4 filed on Jul. 11, 2024, which is hereby incorporated by reference in its entirety.

### BACKGROUND

Driver assistance systems are auxiliary electronic equipment in motor vehicles for assisting the driver in driving situations. Depending on the system, they can provide operational enhancements or efficiencies. For this purpose, among other things, the surroundings, i.e. the environment, of the vehicle is captured using vehicle surroundings sensors, i.e. using sensors on board the vehicle for capturing, for example, other objects, e.g., other road users, traffic signs, roadway markings, and roadway boundaries, from which, for example, information about distances, velocities, or driving courses can be ascertained. Vehicle surroundings sensors can in particular be image sensors or camera sensors, but also, for example, radar, ultrasonic, lidar, and infrared sensors.

In general, every onboard sensor of a new car is calibrated by the vehicle producer before the sale. In vehicles which are produced in assembly line production, wherein the vehicle is automatically moved with the aid of an assembly line or another transport device or possibly also on its own wheels through a production line having various assembly zones, the calibration of the vehicle surroundings sensors can take place after passing through the production line in a calibration station provided for this purpose into which, for example, the vehicle is driven by a driver and out of which it is driven again after a time span required for the calibration.

A sensor calibration method is presented in CN 112 816 222 B, in which a telematics box (T-box) server receives calibration parameters corresponding to a vehicle model code and generates diagnostic instructions for sensors on board a vehicle and then sends them to an onboard T-box, which forwards them to affected control units.

A testing and calibration setup is described in DE 10 2021 212 628 A1, in order to test and calibrate sensors of a vehicle. The setup has a movably mounted marker device for passive information transmission to the vehicle, which additionally has a lidar or radar information unit and is arrangeable fixed in place on the production line, in particular at its end.

A method for calibrating a multi-camera system on board a vehicle is described in U.S. Pat. No. 11,265,514 B2, which vehicle moves along a production line in which calibration images are arranged laterally along the production line, wherein the images recorded by the cameras are evaluated using an onboard image processing sensor.

A method for dynamic calibration of a surroundings sensor of a vehicle is described in DE 10 2022 108 516 A1, wherein the vehicle is moved in a production hall as a navigation environment by means of an external controller, for which purpose the navigation environment is made capable of capturing the position and orientation of the vehicle, deriving control commands therefrom, and moving the vehicle according to the control commands.

A method for calibrating a position sensor in a vehicle is described in DE 10 2018 205 065 A1, in which the vehicle is moved on a predefined calibration route, actual location information is recognized by a position sensor and compared by an onboard processor to stored virtual location information, and a movement thus ascertained is compared to a movement calculated from odometry data of the vehicle.

Driving a vehicle into a calibration station and parking it there during the calibration of the vehicle surroundings sensors, so that the station is blocked for other vehicles, requires human labor and is time-consuming. The calibration in particular becomes even more complex and time-consuming if multiple vehicle surroundings sensors, for example, multiple cameras and radar sensors, are calibrated in the same calibration station, wherein the calibration at a standstill means an additional restriction. Permanently installed pivotable devices having calibration images in or at the end of the production line represent mechanical wear parts and require the most precise possible positioning of the vehicle in relation to the pivotable device. A calibration using onboard processors and the use of odometry data requires their availability in the production process at the time of the calibration.

In the mass production of vehicles, an increase of the production efficiency is one way to reduce costs. Therefore, an increase of the throughput through the production line is desired. For this purpose, for example, stationary times for calibration are to be avoided and an automation of the calibration process is to be improved.

### SUMMARY

The present disclosure relates to a system for calibrating vehicle surroundings sensors of a vehicle in a production line and a method for calibrating vehicle surroundings sensors of a vehicle in a production line, a computer program product, and a computer-readable storage medium.

The present disclosure is can provide a cost-effective alternative option for providing the calibration of vehicle surroundings sensors during the vehicle production process in a production line, which enables a shortening of the overall production time.

According to a first aspect of the disclosure, a system for calibrating vehicle surroundings sensors of a vehicle in a production line comprises a stationary calibration server having at least one memory and one processor, at least one vehicle surroundings sensor module on board a vehicle in a production line, which is connected to at least one vehicle surroundings sensor of the vehicle and is configured, at least in a calibration mode, to progressively transmit vehicle surroundings sensor data captured by the at least one vehicle surroundings sensor via a wireless communication interface to the calibration server when the vehicle is moved through a calibration area, which comprises at least a section of the production line, at least one stationary surroundings sensor, which is configured to capture surroundings sensor data from a set of reference objects in the calibration area through which the vehicle moves and to transmit these data to the calibration server; and at least one stationary position sensor, which is configured, during the movement of the vehicle through the calibration area, to progressively capture a position of the vehicle and transmit associated vehicle position data to the calibration server. The calibration server is configured here to associate captured vehicle position data to the received vehicle surroundings sensor data, which capture the set of reference objects, and, using associated surroundings sensor data from the set of reference objects, to ascertain calibration parameters for the at least one vehicle surroundings sensor and transmit them to the at least one vehicle surroundings sensor module.

The calibration area is a section of the production line in which, in addition to the assembly steps provided in the production sequence in this area, a calibration of the vehicle surroundings sensors of the vehicle, for example, the onboard camera sensors, takes place. For this purpose, the calibration area has an infrastructure of stationary, i.e. fixedly arranged sensors, using which the surroundings, i.e. at least parts of the calibration area with and without vehicle moving through are captured. The stationary sensors are distinguished in that their position and alignment and therefore also their field of view, i.e. the area for which sensor signals can be captured, are known. The stationary sensors are arranged here so that they do not obstruct the performance of the provided assembly steps. For example, it can be provided that the stationary sensors are preferably arranged above the assembly area, for example, on a production hall ceiling. The stationary sensors comprise one or more stationary position sensors for progressively ascertaining the accurate position and possibly alignment of the vehicle. These can be, for example, camera sensors or in particular lidar sensors. Moreover, the stationary sensors comprise one or more stationary surroundings sensors for capturing the calibration area or a part thereof, and one or more, i.e. a set of reference objects in the calibration area.

Reference objects can be, for example, fixed parts of the infrastructure in the calibration area, e.g.: columns of the production hall or specific components of the production line, preferably having clearly recognizable horizontal and/or vertical structures or contours. Other reference objects can be calibration tables or display screens, i.e. displays, the possibly displayed display screen contents of which are captured by one of the stationary surroundings cameras and which can also be captured by an onboard camera as a vehicle surroundings sensor at least in one position of the vehicle on its way through the production line. Stationary surroundings sensors are in particular camera sensors, but can also be other sensors depending on the nature of the reference objects. A stationary position sensor and a stationary surroundings sensor are typically different sensors. In one embodiment, however, these can also be the same sensor, which, for example, captures a reference object and at the same time also the vehicle at a specific position on its way through the production line.

A vehicle surroundings sensor module on board the vehicle has a communication connection to at least one vehicle surroundings sensor or comprises it. When the vehicle surroundings sensors are ready for operation, the vehicle surroundings sensor module in the calibration mode not only can progressively, i.e. continuously or at regular intervals or always upon reaching specific positions, receive sensor signals from the connected sensors, but rather can also establish a wireless communication connection to the stationary calibration server and can transmit vehicle surroundings sensor data associated with the sensor signals to the calibration server. The vehicle surroundings sensor data are transmitted, for example, unprocessed, i.e. without further analysis, to the stationary calibration server for further analysis, so that suitable evaluation software does not have to be provided for this purpose on board the vehicle.

The stationary calibration server is the central element of the calibration system. It receives and aggregates not only the vehicle surroundings sensor data, but also associated position sensor data and surroundings sensor data, which are generated by the stationary position and surroundings sensors from sensor signals respectively captured thereby, and evaluates these data using a suitable calibration program in order to ascertain suitably adapted calibration parameters for the at least one vehicle surroundings sensor on board the vehicle, which parameters (or calibration instructions generated therefrom) are then in turn transmitted to the vehicle surroundings sensor module.

By analyzing and comparing the recorded vehicle surroundings sensor data to recorded surroundings sensor data of reference images with incorporation of exactly captured vehicle position data and known position data of the surroundings sensors, wherein the position data can each also comprise alignment data, as well as possibly current parameter settings of the sensors, exact extrinsic and intrinsic matrices can be determined and improved parameter values for calibrating the vehicle surroundings sensors can be determined and transmitted to the at least one vehicle surroundings sensor module.

The calibration system is embedded in the existing production line and does not require calibration stations connected downstream, which would require additional space in the production facility and additional time for a calibration process connected downstream, and permits a calibration without interruption of the running production process. The calibration process takes place autonomously and in parallel while the vehicles are moved through the production line.

Therefore, the production time can be shortened overall, the efficiency can be increased, and the vehicle throughput in the production facility can be increased by the described system configuration. Moreover, the calibration only requires the transmission of the vehicle surroundings sensor data to the calibration server. Other vehicle parameters do not necessarily have to be captured and the respective vehicle also does not have to itself ascertain its own position, alignment, or velocity.

In one embodiment, the set of reference objects comprises at least one display means for displaying various calibration images. In other words, the display means are reference objects which are detectable in the recordings of a vehicle surroundings camera and a stationary surroundings camera. The display means can be, for example, suitable calibration tables or in particular actuatable display screens, i.e. displays, on which suitable calibration images can be displayed as reference images.

In one exemplary embodiment, the calibration server is configured for the purpose of dynamically controlling the display of the various calibration images by the at least one display means. In this embodiment, the at least one display means is a display means for dynamically displaying various calibration images. I.e. the various calibration images can be displayed in chronological succession controlled by the calibration server, wherein it can also be provided that the calibration images are displayed or adapted depending on a position, alignment, or velocity of the vehicle, the type and/or previous settings of the vehicle surroundings sensor to be calibrated. The display means for dynamically displaying various calibration images can be, for example, a display screen, i.e. a display. If it is intended that the respective previous, thus currently still valid settings of the vehicle surroundings sensor to be calibrated are to be taken into consideration, it is also possible, for example, in an iterative automatic process using multiple displays along the movement path of the vehicle through the calibration area of the production line to transmit updated calibration parameters to the vehicle moved through the production line and to test their effects at the next display, in order to then possibly automatically select or adapt the suitable calibration image for the display after that, in order to further improve the result without interrupting the assembly process of the vehicle which continues to run in parallel here.

In one embodiment, the calibration server can be configured to use the vehicle surroundings sensor data directly for an update of the reference image currently displayed on the same display in order to immediately in turn receive updated vehicle surroundings sensor data as long as the same display is still located in the recording area of the vehicle surroundings sensor to be calibrated. In other words, an improved iterative calibration in a real-time feedback loop is enabled, even if only a single display is used for this purpose.

In a further embodiment of the system, the set of reference objects comprises at least one stationary structure in the calibration area of the production line. A stationary structure can be, for example, a fixed part of the infrastructure in the calibration area, for example, one or more columns of the production hall or specific components of the production line, preferably having a distinctive shape, which are suitable as exactly detectable orientation points. These can then be used for the automatic calibration, for example, in that the detected reference objects are compared with an existing map, from which the positions of the reference objects can be inferred, in particular with a three-dimensional map of at least the calibration area or the entire production line or the entire production facility or production hall, by which the accuracy of the calibration can be improved.

It is therefore also provided in one embodiment of the system that a 3D surroundings map of at least the calibration area of the production line having information at least on the one or more reference objects is stored in the memory of the calibration server. The 3D surroundings map is created, for example, as a 3D scan of the production line or the production facility. Since the positions and alignments of the stationary infrastructure sensors can be established by way of the 3D map and those of the onboard vehicle surroundings sensors can be established by the stationary infrastructure sensors with high accuracy, the calibration server can ascertain the calibration parameters even more precisely, so that the vehicle surroundings sensors can be configured reliably.

In one embodiment, the at least one stationary position sensor comprises a lidar sensor (lidar means light detection and ranging). This enables three-dimensional laser scanning of the surroundings and therefore both precise optical distance measurements and also velocity measurements of detected vehicles, so that an exact position determination of the vehicle is enabled if the position of the lidar sensor is known. A position determination is fundamentally also possible using other sensors, for example, camera sensors, wherein the position determination is then carried out by image analysis of digital camera images.

In a further embodiment, the calibration server is configured to compare reference images recorded by the at least one stationary surroundings sensor with images recorded by the at least one vehicle surroundings sensor and to carry out ISP tuning, i.e. an improvement of the settings of the image signal processing (ISP). In the provided ISP tuning, the image quality is not only adapted by an adaptation of, for example, saturation and contrast, but rather parameters of the image signal processing are changed, for example, in order to optimize the image sharpness and the color distribution so that the image details enable an improved calibration of the vehicle surroundings sensor.

According to a second aspect of the disclosure, a method for calibrating vehicle surroundings sensors of a vehicle in a production line using a system according to the first aspect of the disclosure comprises detecting an entry of a vehicle moving through a driving line into a calibration area of the production line, activating a calibration mode of at least one vehicle surroundings sensor module, which is connected to at least one vehicle surroundings sensor, on board the vehicle, and then progressively transmitting vehicle surroundings data captured using the at least one vehicle surroundings sensor via a wireless communication interface to a stationary calibration server having at least one memory and one processor.

The method additionally comprises capturing, using at least one stationary surroundings sensor, surroundings sensor data relating to a set of reference objects in the calibration area of the production line through which the vehicle moves, and transmitting the captured surroundings sensor data to the calibration server, and progressively capturing, using at least one stationary position sensor, a position of the vehicle during the movement of the vehicle through the calibration area and transmitting associated vehicle position data to the calibration server.

Moreover, the method comprises associating, by way of the calibration server, captured vehicle position data with received vehicle surroundings sensor data, which capture the set of reference objects, ascertaining, using associated surroundings sensor data of the set of reference objects, calibration parameters for the at least one vehicle surroundings sensor, and transmitting the ascertained calibration parameters to the at least one vehicle surroundings sensor module.

In one embodiment, in which the set of reference objects has at least one display means for displaying various calibration images, the method moreover comprises dynamically controlling, by way of the calibration server, a display of various calibration images by the at least one display means.

According to a third aspect of the disclosure, a computer program product comprises code components which, when they are executed by a processor of a calibration server of a system for calibrating vehicle surroundings sensor of a vehicle in a production line using a system according to the first aspect of the disclosure, cause the system to carry out a method according to the second aspect of the disclosure. The code components, i.e. the program code, of the computer program product correspond here to a computer program comprising commands, using which the calibration server is caused to carry out steps of the method. The calibration server comprises at least one processor and one memory here.

And according to a fourth aspect of the disclosure, a computer-readable data carrier has a computer program product according to the third aspect of the disclosure. A computer-readable data carrier can be both a computer-readable storage medium and a data carrier signal. A computer-readable storage medium is a medium suitable for storing software, for example, a CD-ROM, DVD, Blu-ray disk, a USB stick, a hard drive, etc. A data carrier signal enables a wired or wireless transmission of the code components.

Therefore, the advantages and features of the system according to the disclosure for calibrating vehicle surroundings sensors of a vehicle in a production line, including its embodiments, are also implemented in the scope of a method for calibrating vehicle surroundings sensors of a vehicle in a production line and a computer program product and a computer-readable data carrier.

### BRIEF SUMMARY OF THE DRAWINGS

Further advantages of the present disclosure are apparent from the detailed description and the figures. The disclosure will also be explained in more detail hereinafter in conjunction with the following description of exemplary embodiments with reference to the appended figures. In the figures:

FIG. 1 shows a schematic representation of a first example of a system for calibrating vehicle surroundings sensors of a vehicle in a production line according to one embodiment;

FIG. 2 shows a schematic illustration of a second example of a system for calibrating vehicle surroundings sensors of a vehicle in a production line according to a further embodiment; and

FIG. 3 shows a schematic representation of an example of a method for calibrating vehicle surroundings sensors of a vehicle in a production line according to still a further embodiment.

In the figures, identical or similar reference signs indicate identical or similar elements, if not indicated otherwise.

It is apparent that other embodiments can be used and structural or logical changes can be performed without deviating from the scope of protection of the present invention. It is apparent that the features of the various exemplary embodiments described above and hereinafter can be combined with one another if not specifically indicated otherwise. The description is therefore not to be interpreted in a restrictive sense, and the scope of protection of the present invention is defined by the appended claims.

### DESCRIPTION

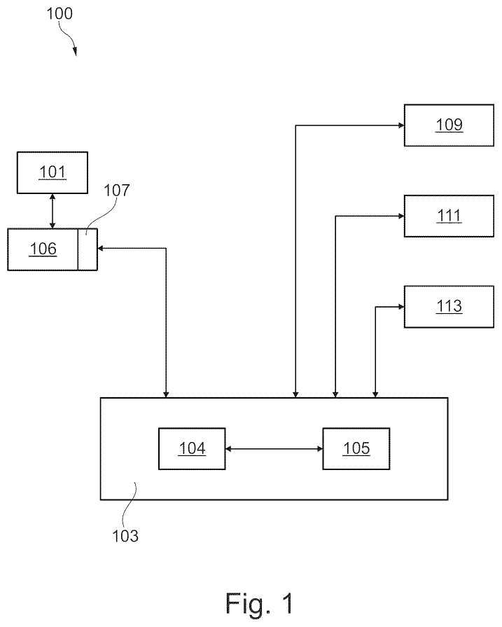

FIG. 1 shows a schematic representation of a first example of a system 100 for calibrating vehicle surroundings sensors 101 of a vehicle in a production line according to an embodiment.

The system 100 has, as a central component for ascertaining the calibration parameters for the one or the multiple vehicle surroundings sensors, i.e. the onboard sensors of each vehicle in the production line, using which it can capture its surroundings, in particular onboard camera sensors, but also, for example, lidar, radar, or infrared sensors, a stationary calibration server 103 having at least one memory 104 and one processor 105. Stationary components of the system are part of the infrastructure, i.e. do not have to be present on board the vehicle. The presented system 100 provides that at least in a calibration mode, the one or the multiple vehicle surroundings sensors 101 are activated and that on board the vehicle, at least one vehicle surroundings sensor module 106 connected to the vehicle surroundings sensor or sensors 101 is provided, which, via an associated directly connected or indirectly connected, for example, via an onboard communication bus (for example, CAN bus), wireless communication interface 107, progressively transmits vehicle surroundings sensor data captured by the vehicle surroundings sensor or sensors 101 to the calibration server 103 when the vehicle is moved through a calibration area, i.e. a section of the production line in which the calibration of the vehicle surroundings sensors 101 is to take place. This section can comprise a partial area or also the entire production line.

The system 100 additionally has as part of the calibration infrastructure at least one stationary surroundings sensor 109, which is configured to capture surroundings sensor data from a set of reference objects in the calibration area through which the vehicle moves, and to transmit these data to the calibration server 103. A reference object has a known fixed position and is, for example, a stationary structure in the calibration area of the production line, which can be captured by a surroundings sensor and by a vehicle surroundings sensor. A reference object is also a stationary display means 113 for displaying calibration images, in particular a display actuatable by the calibration server 103, on which it can have calibration images displayed. The positions and alignments of the reference objects can be stored in a 3D surroundings map of the calibration area of the production line, which can be stored in the memory 104 of the calibration server 103.

The system 100 for calibrating vehicle surroundings sensors 101 of a vehicle in a production line additionally has at least one stationary position sensor 111, in order to progressively capture a position of the vehicle therewith while it is moved through the calibration area. The associated vehicle position data are transmitted to the calibration server 103. Depending on the embodiment, various sensor types can be used as position sensors and surroundings sensors can also be used as position sensors. Exact distances can be ascertained, for example, using lidar sensors and accurate vehicle position data can be ascertained therefrom.

The calibration server 103 is configured to associate captured vehicle position data with the received vehicle surroundings sensor data, which capture the set of reference objects, and to ascertain calibration parameters for the vehicle surroundings sensor or sensors 101 using associated surroundings sensor data from the set of reference objects and transmit these parameters wirelessly to the vehicle surroundings sensor module 106.

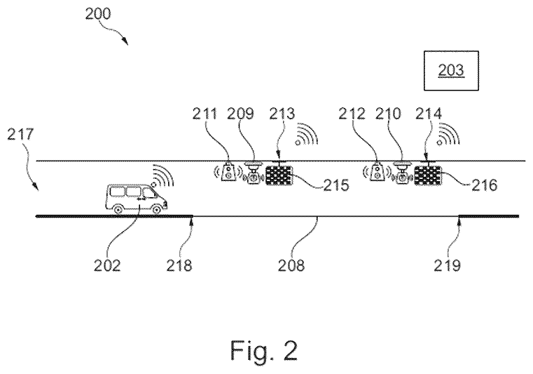

FIG. 2 shows a schematic representation of a second example of a system 200 for calibrating vehicle surroundings sensors of a vehicle 202 in a production line 217 according to a further embodiment. The system 200 shown in FIG. 2 also has a stationary calibration server 203. This server is wirelessly connected both to the vehicle surroundings sensor module or modules on board the vehicle 202 and to the stationary infrastructure sensors in order to receive their sensor data. A vehicle surroundings sensor module on board the vehicle 202 is configured to transmit vehicle surroundings sensor data progressively captured in a calibration mode to the calibration server 203 when it is moved through a calibration area 208 of the production line 217. For this purpose, it is captured when the vehicle 202 reaches the beginning 218 of the calibration area. The calibration is completed when the vehicle leaves the area again at the end 219 of the calibration area 208 of the production line 217. In the example shown, the system 200 in the calibration area 208 has two camera sensors as stationary surroundings sensors 209, 210, using which surroundings sensor data, in particular also of reference objects in the calibration area 208, are captured and transmitted to the calibration server 203. Various calibration images 215, 216, which are displayed by two displays as the display means 213, 214, are captured by the vehicle surroundings sensors of the vehicle 202 and the surrounding sensors 209, 210, wherein the calibration server 203 dynamically controls the display of the various calibration images 215, 216 as a function of various parameters, among other things the current position of the vehicle 203. This is ascertained using position sensors. In the example shown, the system has for this purpose two lidar sensors as stationary position sensors 211, 212, which progressively capture the position of the vehicle 202 during the movement of the vehicle 202 through the calibration area 208 and transmit the associated vehicle position data to the calibration server 203.

The calibration server 203 is configured to associate vehicle position data with the received vehicle surroundings sensor data, which capture reference objects, and, using associated surroundings sensor data of the reference objects, to ascertain calibration parameters for the vehicle surroundings sensors of the vehicle 202 and transmit them to the vehicle 202.

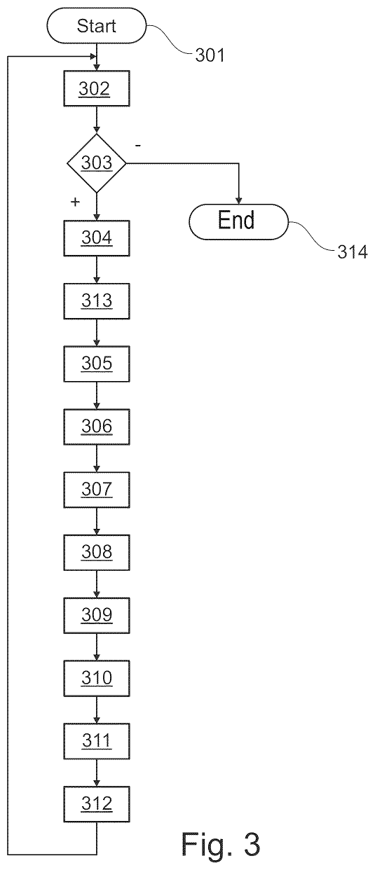

FIG. 3 shows a schematic representation of an example of a method 300 for calibrating vehicle surroundings sensors of a vehicle in a production line according to still a further embodiment of the disclosure. The method 300 begins in a starting state 301, in which vehicles are transported through the production line for assembly and a calibration server of the calibration system is configured to carry out steps of the calibration method by loading a computer program product from the memory of the calibration server.

In a first step, an entry of a vehicle moved through the production line into a calibration area of the production line is detected 302. It is then checked 303 whether an entry into the calibration area has taken place. If this is the case (identified by “+” in FIG. 3), a calibration mode of at least one vehicle surroundings sensor module, which is connected to at least one vehicle surroundings sensor, on board the vehicle is activated 304. In the described embodiment of the method 300, a set of reference objects has at least one display means for displaying various calibration images and the method provides a dynamic control 313, by the calibration server, of a display of various calibration images by the at least one display means.

In addition, vehicle surroundings sensor data captured using the at least one vehicle surroundings sensor are progressively transmitted 305 via a wireless communication interface to the stationary calibration server having at least one memory and one processor, and surroundings sensor data relating to the set of reference objects in the calibration area of the production line through which the vehicle moves are captured 306 using at least one stationary surroundings sensor, and the captured surroundings sensor data are transmitted 307 to the calibration server.

In addition, a position of the vehicle is progressively captured 308 using at least one stationary position sensor during the movement of the vehicle through the calibration area and associated vehicle position data are transmitted 309 to the calibration server.

Captured vehicle position data are associated 310 with received vehicle surroundings sensor data, which capture the set of reference objects, by the calibration server, calibration parameters for the at least one vehicle surroundings sensor are ascertained 311 using associated surroundings sensor data of the set of reference objects. Finally, the ascertained calibration parameters are transmitted 312 to the at least one vehicle surroundings sensor module.

The method 300 is continued in the described embodiment with the step of detecting 302 the entry of a next vehicle moved through the production line into the calibration area of the production line. If check 303 whether an entry into the calibration area has taken place then has the result that this is not the case (identified with “−” in FIG. 3), the method passes into an end state 314.

The steps of the method are indicated in a sequential order in FIG. 3. However, it is apparent that method steps, although they are described according to this sequential order, can partially be carried out in an order other than that described here, in particular also simultaneously or in succession, once or multiple times.

### List of Reference Numerals

100 system for calibrating vehicle surroundings sensors
101 vehicle surroundings sensor
103 stationary calibration server
104 memory
105 processor
106 vehicle surroundings sensor module
107 wireless communication interface
109 stationary surroundings sensor
111 stationary position sensor
113 display means
200 system for calibrating vehicle surroundings sensors
202 vehicle
203 stationary calibration server
208 calibration area
209 stationary surroundings sensor
210 stationary surroundings sensor
211 stationary position sensor
212 stationary position sensor
213 display means
214 display means
215 calibration image
216 calibration image
217 production line
218 beginning of the calibration area
219 end of the calibration area
300 method for calibrating vehicle surroundings sensors
301 start
302 detecting the entry of a vehicle into the calibration area of the production line
303 checking whether a vehicle entry was established
304 activating a calibration mode
305 progressively transmitting vehicle surroundings sensor data to calibration server
306 capturing surroundings sensor data relating to reference objects
307 transmitting the captured surroundings sensor data to calibration server
308 progressively capturing a position of the vehicle
309 transmitting associated vehicle position data to calibration server
310 associating vehicle position data with vehicle surroundings sensor data
311 ascertaining calibration parameters for the vehicle surroundings sensor
312 transmitting the calibration parameters to the vehicle surroundings sensor module
313 dynamically controlling a display of various calibration images
314 end

1-11. (canceled)

12. A system for calibrating vehicle surroundings sensors of a vehicle:
a stationary calibration server having at least one memory and one processor;
at least one vehicle surroundings sensor module connected to at least one vehicle surroundings sensor and that is configured in a calibration mode to progressively transmit vehicle surroundings sensor data captured by the at least one vehicle surroundings sensor via a wireless communication interface to the calibration server when the vehicle is moved through a calibration area that includes a section of a production line;
at least one stationary surroundings sensor, which is configured to capture surroundings sensor data of a set of reference objects in the calibration area, through which the vehicle moves, and to transmit these data to the calibration server; and
at least one stationary position sensor, which is configured, during the movement of the vehicle through the calibration area, to progressively capture a position of the vehicle and transmit associated vehicle position data to the calibration server; wherein
the calibration server is configured to associate captured vehicle position data with the received vehicle surroundings sensor data, which capture the set of reference objects, and, using associated surroundings sensor data of the set of reference objects, to ascertain calibration parameters for the at least one vehicle surroundings sensor and transmit these parameters to the at least one vehicle surroundings sensor module.

13. The system of claim 12, wherein the set of reference objects comprises at least one display for displaying various calibration images.

14. The system of claim 13, wherein the calibration server is configured to dynamically control the display of the various calibration images by the at least one display.

15. The system of claim 12, wherein the set of reference objects comprises at least one stationary structure in the calibration area.

16. The system of claim 12, wherein a 3D surroundings map of at least the calibration area having information at least on the one or the multiple reference objects is stored in the memory of the calibration server.

17. The system of claim 12, wherein the at least one stationary position sensor comprises a lidar sensor.

18. The system of claim 12, wherein the calibration server is configured to compare reference images recorded by the at least one stationary surroundings sensor with images recorded by the at least one vehicle surroundings sensor and to carry out image signal processing (ISP) tuning.

19. A method for calibrating vehicle surroundings sensors of a vehicle, comprising:
detecting an entry of a vehicle moved through a production line into a calibration area of the production line;
activating a calibration mode of at least one vehicle surroundings sensor module, which is connected to at least one vehicle surroundings sensor, on board the vehicle;
progressively transmitting vehicle surroundings sensor data captured using the at least one vehicle surroundings sensor via a wireless communication interface to a stationary calibration server having at least one memory and one processor;
capturing, using at least one stationary surroundings sensor, surroundings sensor data relating to a set of reference objects in the calibration area of the production line through which the vehicle moves, and transmitting the captured surroundings sensor data to the calibration server;
progressively capturing, using at least one stationary position sensor, during the movement of the vehicle through the calibration area, a position of the vehicle and transmitting associated vehicle position data to the calibration server;
associating, by the calibration server, captured vehicle position data with received vehicle surroundings sensor data, which capture the set of reference objects;
ascertaining, using associated surroundings sensor data of the set of reference objects, calibration parameters for the at least one vehicle surroundings sensor; and
transmitting the ascertained calibration parameters to the at least one vehicle surroundings sensor module.

20. The method of claim 19, wherein the set of reference objects has at least one display means for displaying various calibration images, the method further comprising dynamically controlling, by the calibration server, a display of various calibration images by the at least one display means.

21. The method of claim 19, wherein the set of reference objects comprises at least one stationary structure in the calibration area.

22. The method of claim 19, wherein a 3D surroundings map of at least the calibration area having information at least on the one or the multiple reference objects is stored in the memory of the calibration server.

23. The method of claim 19, wherein the at least one stationary position sensor comprises a lidar sensor.

24. The method of claim 19, wherein the calibration server is configured to compare reference images recorded by the at least one stationary surroundings sensor with images recorded by the at least one vehicle surroundings sensor and to carry out image signal processing (ISP) tuning.
